(19) United States
(12) Patent Application Publication
(10) Pub. No.: US 2024/0046035 A1
(43) Pub. Date: Feb. 8, 2024

(54) PROGRAM, FILE GENERATION METHOD, INFORMATION PROCESSING DEVICE, AND INFORMATION PROCESSING SYSTEM

(71) Applicant: ARTIS SOLUTIONS CO., LTD., Tokyo (JP)

(72) Inventor: Shoichi YAMAMURA, Tokyo (JP)

(21) Appl. No.: 18/274,447

(22) PCT Filed: Nov. 18, 2022
(86) PCT No.: PCT/JP2022/042797

§ 371 Date: Jul. 26, 2023

(30) Foreign Application Priority Data
Jan. 5, 2022 (JP) 2022-000623

(51) Int. Cl. G06F 40/221; G06F 3/0484

(52) U.S. Cl. CPC G06F 40/221; G06F 3/0484

(57) ABSTRACT

A program causes a computer to execute a process, the process includes: receiving a designation of a presentation file that includes a plurality of slides, each including a note; extracting a note from one of the plurality of slides; obtaining audio data obtained by speech synthesis of the note; playing the obtained audio data; receiving an instruction to edit the note; writing the edited note into the slide; and converting the presentation file including the slide into a file including the audio data.

### CROSS REFERENCE TO RELATED APPLICATIONS

This application is a U.S. National Phase Application under 35 U.S.C. 371 of International Application No. PCT/JP2022/042797, filed on Nov. 18, 2022, which claims priority to Japanese Patent Application No. 2022-000623, filed on Jan. 5, 2022. The entire disclosures of the above applications are expressly incorporated by reference herein.

### BACKGROUND

### Technical Field

The present invention relates to a technique for generating a file that includes audio data from a presentation file.

### Related Art

Known in the art is a technique for generating video from a still image and text. For example, JP 2011-82789 A discloses a system that automatically generates video with audio from a still image and text for Internet video distribution.

In JP 2011-82789 A a technique is disclosed whereby voice in a generated video is automatically synthesized from text. However, the technique is subject to a limitation in that only predetermined speech synthesis is possible, which results, for example, in production of a monotonous voice lacking in intonation. Thus, room for improvement is available.

In contrast, the present invention provides a technique for generating a file that includes audio data into which a greater diversity of audio can be added from a presentation file.

### SUMMARY

According to one aspect of the present disclosure, there is provided a program for causing a computer to execute a process, the process including: receiving a designation of a presentation file that includes a plurality of slides, each including a note; extracting a note from one of the plurality of slides; obtaining audio data obtained by speech synthesis of the note; playing the obtained audio data; receiving an instruction to edit the note; writing the edited note into the slide; and converting the presentation file including the slide into a file including the audio data.

The process may further includes receiving an input to designate a voice for playing the audio data.

The process may further includes: receiving an input to designate a speech synthesis engine which carries out speech synthesis of the note; and obtaining the audio data from the designated speech synthesis engine.

The process may further includes: displaying on a display a UI object for editing the note.

The UI object may include a button for inserting a tag of SSML (Speech Synthesis Markup Language).

The UI object may include a button for testing and playing the audio data.

The UI object may include a button for testing and playing the file including the audio data.

The process may further includes obtaining a translation of the note, in a target language.

The process may further include receiving an input to designate the translation target language.

According to another aspect of the disclosure, there is provided a file generation method including: receiving a designation of a presentation file that includes a plurality of slides, each including a note; extracting a note from one of the plurality of slides; obtaining audio data obtained by speech synthesis of the note; playing the obtained audio data; receiving an instruction to edit the note; writing the edited note to a slide; and converting the presentation file including the slide to a file including the audio data.

According to yet another aspect of the disclosure, there is provided an information processing device including: a file receiving means for receiving a designation of a presentation file including plural slides each including a note; an extracting means for extracting a note from one of the plurality of slides; an obtaining means for obtaining audio data obtained by speech synthesis of the extracted note; a playing means for playing the obtained audio data; an instruction receiving means for receiving an instruction to edit the extracted note; a writing means for writing the edited note to the slide; and a converting means for converting the presentation file including the edited slide into a file including the audio data.

According to yet another aspect of the disclosure, there is provided an information processing system including: a file receiving means for receiving a designation of a presentation file including plural slides each including a note; an extracting means for extracting a note from one of the plurality of slides; an obtaining means for obtaining audio data obtained by speech synthesis of the extracted note; a playing means for playing the obtained audio data; an instruction receiving means for receiving an instruction to edit the extracted note; a writing means for writing the edited note to the slide; and a converting means for converting the presentation file including the slide into a file including the obtained audio data.

### Advantageous Effects

The present invention enables generation, from a presentation file, a file that includes audio data, into which a greater variety of audio can be incorporated.

### BRIEF DESCRIPTION OF THE DRAWINGS

FIG. 1 shows an outline of a file generation system 1 according to an embodiment.

FIG. 2 shows an exemplary diagram illustrating a functional configuration of a file generation system.

FIG. 3 shows an exemplary hardware configuration of a user terminal 20.

FIG. 4 shows an exemplary flowchart of an operation of a file generation system.

FIG. 5 shows an exemplary configuration screen.

FIG. 6 shows an exemplary flowchart illustrating a configuration process.

FIG. 7 shows an exemplary pronunciation dictionary.

FIG. 8 shows an exemplary configuration of database 113.

FIG. 9 shows exemplary UI objects for configuration up-tests.

FIG. 10 shows an exemplary dialog box for designating a pause time.

FIG. 11 shows an exemplary dialog box for designating a degree of emphasis.

FIG. 12 shows an exemplary dialog box for designating a speed.

FIG. 13 shows an exemplary dialog box for designating a pitch of a voice.

FIG. 14 shows an exemplary dialog box for designating a volume.

### DETAILED DESCRIPTION

### 1. Configuration

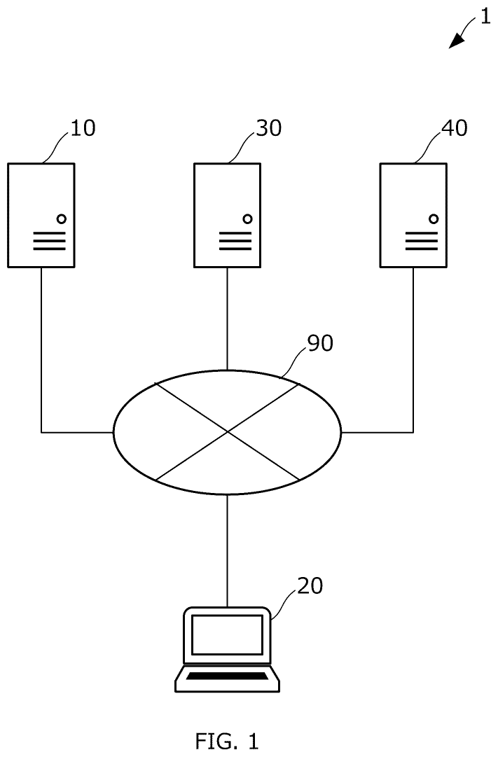

FIG. 1 shows an outline of a file generation system 1 according to an embodiment of this invention. File generation system 1 provides a service for generating a file that includes audio data, from a presentation file (hereinafter referred to as “file generation service with audio data”). The file that includes audio data is a file in which data for outputting audio at user terminal 20 and data for displaying video at user terminal 20 are integrated. The file that includes audio data is, for example, a video file in a predetermined format such as a MPEG4. File generation system 1 is used, for example, in an educational setting such as for employee education in a company, or for education in an educational institution. File generation system 1 includes server 10, user terminal 20, server 30, and server 40. Server 10 is a computer device that functions as a server in the file generation service that includes audio data. User terminal 20 is a computer device that functions as a client in the file generation service. Server 30 is a server that provides a speech synthesis service that synthesizes speech from text (or a character string) (namely, converts text into audio). Server 40 is a server that provides a translation service that translates text from a source language into a target language.

The presentation file is a file for use in a presentation application (for example, PowerPoint (registered trademark) of Microsoft Corporation), and includes a plurality of slides. The plurality of slides each includes a slide main body and a note. The slide main body includes content that is displayed to an audience upon execution for presentation, and includes at least one of an image and a character. The note includes content that is not displayed to the audience, but is displayable to a presenter when the presentation is executed, and includes a character string. File generation system 1 converts the slide main body into video and the note into audio within slides included in the presentation file, and then synthesizes the slides to generate a file that includes audio data (for example, a video file).

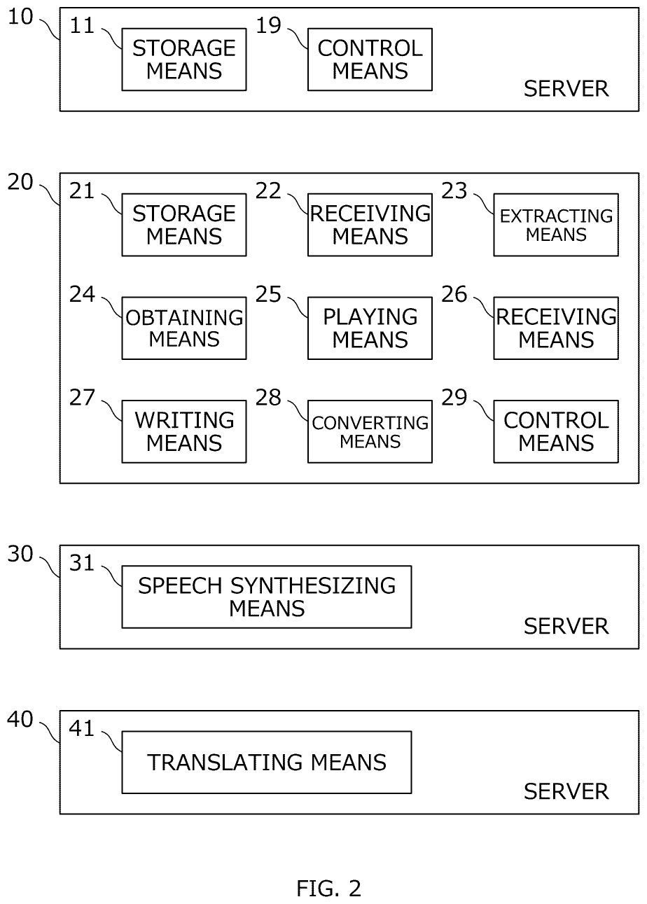

FIG. 2 shows an exemplary functional configuration of file generation system 1. File generation system 1 includes storage means 11, control means 19, storage means 21, receiving means 22, extracting means 23, obtaining means 24, playing means 25, receiving means 26, writing means 27, converting means 28, control means 29, speech synthesizing means 31, and translation means 41. Storage means 11 and control means 19 are implemented in server 10. Storage means 21, receiving means 22, extracting means 23, obtaining means 24, playing means 25, receiving means 26, writing means 27, converting means 28, and control means 29 are implemented in user terminal 20. Speech synthesizing means 31 is implemented in server 30. Translation means 41 is implemented in server 40.

In server 10, storage means 11 stores various types of data and programs. Controlling means 19 performs various controls.

In user terminal 20, storage means 21 stores various types of data and programs. Receiving means 22 (an example of a file receiving means) receives an input to designate a presentation file including plural slides each of which includes a note. Extracting means 23 extracts a note from one of the slides. Obtaining means 24 obtains audio data obtained by speech synthesis of the extracted note. Playing means 25 plays audio in accordance with the audio data. Receiving means 26 (an example of an instruction receiving means) receives an instruction to edit the note. Writing means 27 writes the edited note to the slide. Converting means 28 converts the presentation file including the edited slide into a video file. Controlling means 29 performs various controls.

In server 30, speech synthesizing means 31 converts the text data into audio data in accordance with a request from user terminal 20. In server 40, translation means 41 translates the original text into a translation of a designated language in accordance with a request from user terminal 20.

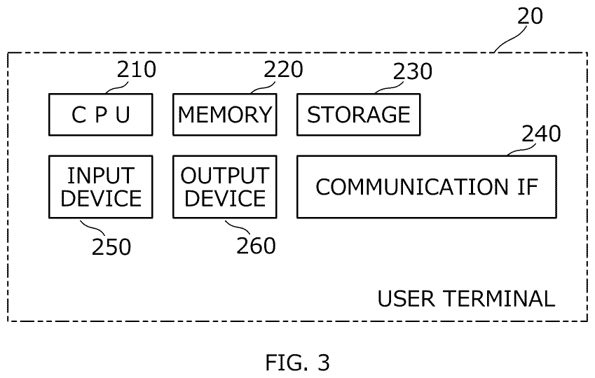

FIG. 3 shows an exemplary hardware configuration of user terminal 20. User terminal 20 is a computer device or an information processing device having CPU (Central Processing Unit) 210, memory 220, storage 230, communication IF (Interface) 240, input device 250, and output device 260. CPU 210 is a device that executes a process in accordance with a program. Memory 220 is a storage device that functions as a workspace when CPU 110 executes a process, and includes, for example, RAM (Random Access Memory) and ROM (Read Only Memory). Storage 230 is a storage device that stores data/programs, and includes, for example, a SSD (Solid State Drive) or a HDD (Hard Disk Drive). Communication IF 240 communicates with other computer devices in accordance with a predetermined communication standard (e.g., LTE (registered trademark), Wi-Fi (registered trademark), or Ethernet (registered trademark). Input device 250 is a device that inputs an instruction or information to user terminal 20, and includes, for example, at least one of a touch screen, a keypad, a keyboard, a pointing device, and a microphone. Output device 260 is a device that outputs information, and includes, for example, a display and a speaker.

In this example, the program stored in storage 230 includes a program (hereinafter referred to as a “file generation program”) that causes the computer device to function as a client of file generation system 1. When CPU 210 executes the client program, the functions shown in FIG. 2 are implemented in the computer device.

When CPU 210 executes the server program, at least one of memory 220 and storage 230 is an example of storage means 21, CPU 210 is an example of receiving unit 22, while extracting means 23, obtaining means 24, receiving unit 26, writing means 27, converting means 28, control means 29, and output device 260 are each examples of playing means 25.

Although detailed explanation is omitted, server 10, server 30, and server 40 are computer devices each having a CPU, a memory, a storage, and a communication IF. The storage stores a program that causes a computer device to function as server 10, server 30, or server 40 of file generation system 1. When CPU executes this program, the functions shown in FIG. 2 are implemented in the computer device.

### 2. Operation

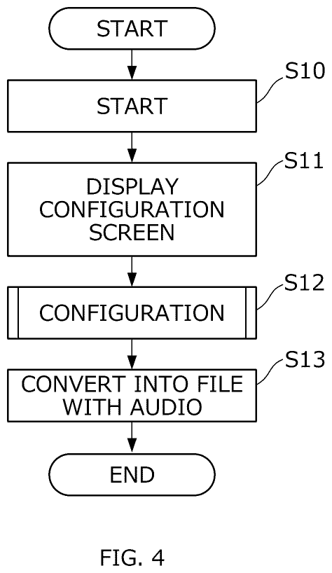

FIG. 4 shows a sequence chart illustrating an operation of file generation system 1. In the following, software such as a file generation program may be described as a subject of processing, which means that a hardware element such as CPU 210 that executes the file generation program, executes the process in cooperation with other hardware elements.

The user starts (at step S10) the file generation program in user terminal 20. When activated, the file generation program displays (at step S11, FIG. 4) a screen (hereinafter referred to as a “configuration screen”), which is used for making configurations to generate a file (a video file in this example) including audio from the presentation file. The file generation program may perform a well-known login process such as inputting an ID and a password prior to displaying the configuration window.

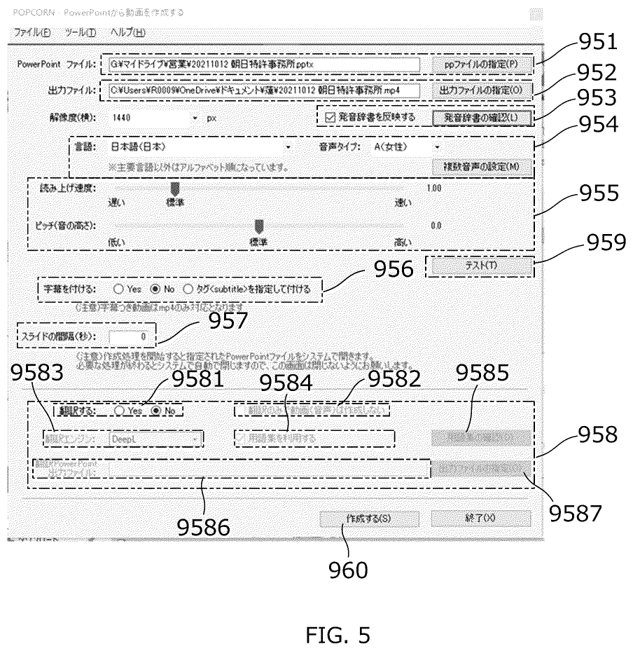

FIG. 5 shows an exemplary configuration screen. The configuration screen includes objects 951 to 960. The file generation program performs (at step S12) a configuration process for generating a file (a video file in this example) including audio data from the presentation file via the configuration screen responsive to an instruction input by the user.

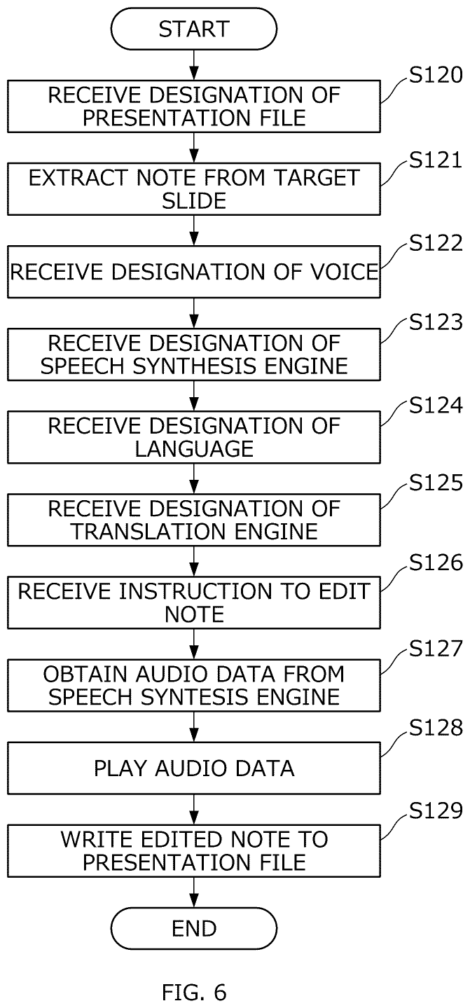

FIG. 6 shows a flow chart illustrating a configuration process at step S12. Hereinafter, the configuration process will be described with reference to FIG. 5 and FIG. 6, and a screen example of the file generation program. It is of note that while for convenience the configuration processing is described in the flowchart in FIG. 6, the processing of each step need not be performed in the order shown in the flowchart, and an order of steps may be replaced with an order of other steps, or some steps may be omitted.

Referring to FIG. 5, object 951 is a UI object for designating a presentation file for conversion into a file that includes audio data. If the user presses a button at the right side of object 951, the file generation program displays a dialog for selecting a file. If a file is selected in this dialog, the name of the file is displayed in the text box on the left side of object 951. The file generation program receives (at step S120, FIG. 6) an input to designate a presentation file to be processed in object 951.

Object 952 is a UI object for designating an output file, that is, a converted file that includes audio data. If the user presses a button at the right side of object 952, the file generation program displays a dialog for selecting a folder. The user selects the folder displayed in the dialog, and enters a file name in a text box at the left side of object 952 to store the file that includes the audio data. If the user overwrites a previously saved file, the existing file is overwritten. The user can edit the file name in the text box. The generated video is thus saved with the edited file name, and the file generation program thereby receives the converted file that includes the audio data in object 952.

Object 953 is a UI object that designates whether a pronunciation dictionary is used. If a checkbox at the left of object 953 is checked, the file generation program designates use of the pronunciation dictionary. If the checkbox is not checked, the file generation program designates the pronunciation dictionary as not to be used. If the button at the right of object 953 is pressed, the file generation program displays a pronunciation dictionary. In this example, the pronunciation dictionary is stored in database 112 of server 10. The file generation program accesses server 10 to read the pronunciation dictionary.

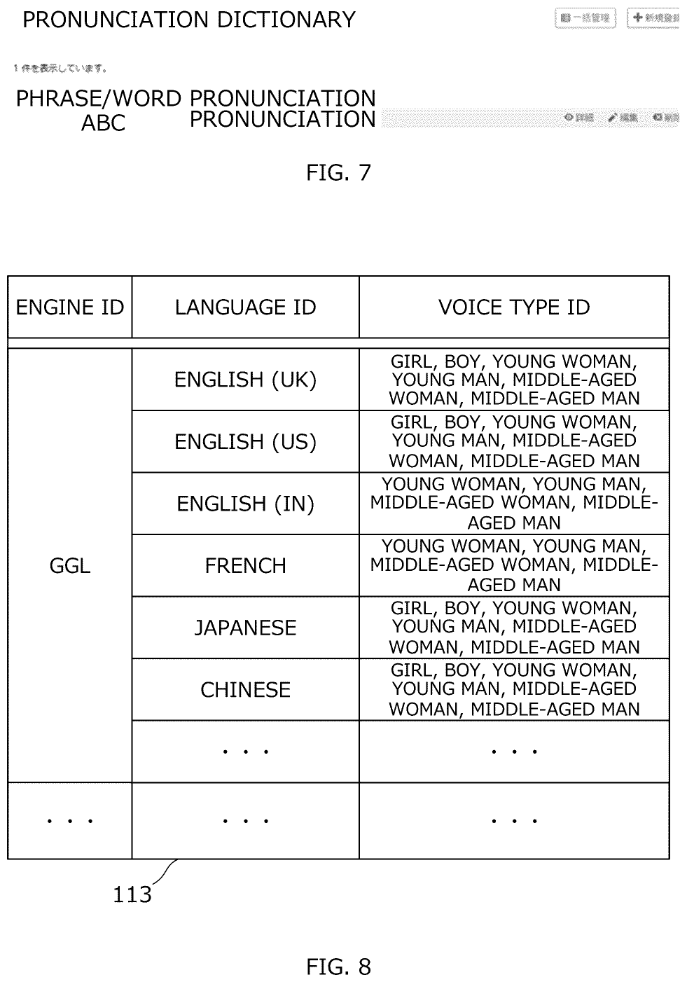

FIG. 7 shows an exemplary pronunciation dictionary. The pronunciation dictionary includes plural records. Each record includes items “phrase/word” and “pronunciation.” In the item “phrase/word,” a phrase or word for which a pronunciation is to be designated is registered. As shown, a phrase “ABC” is registered. In the item “pronunciation,” pronunciation of a word or phrase is registered. The figure shows an example designating a Japanese pronunciation, with a pronunciation “a: be: tse:” being designated. Although detailed illustration is omitted, each record includes an item that designates a language; and a pronunciation may be designated for each designated language.

Referring to FIG. 5, object 954 is a UI object for designating a language and a speech type for use in speech synthesis. In this example, the file generation program is able to access plural speech synthesis engines. The plural speech synthesis engines are provided by different operators and have different characteristics. For example, one speech synthesis engine has multiple corresponding languages, and another speech synthesis engine has multiple speech types. Storage means 11 in server 10 stores database 113. Database 113 is a database in which attributes of the speech synthesis engine are recorded. The file generation program refers to database 113 and displays a pull-down menu of object 954.

FIG. 8 shows an exemplary configuration of database 113. Database 113 includes plural records. The records include an engine ID, a language ID, and at least one speech-type ID. The engine ID includes identification information of the speech synthesis engine. The language ID includes identification information of a language to be speech-synthesized. The speech-type ID is identification information that indicates a type of speech used for speech synthesis (e.g., a girl, a boy, a young woman, a young man, a middle-aged woman, or a middle-aged man, and so on). In the embodiment illustrated in FIG. 8, the speech synthesis engine having the engine ID “GGL” corresponds to the language ID “English (UK),” and shows that speech synthesis can be performed with six types of speech: speech type “girl,” “boy,” “young woman,” “young man,” “middle-aged woman,” “middle-aged man,” and so on.

In this example, multiple speech types may be combined in a single file that includes audio data. Object 954 has a button for “configuration of plural voices.” If the user presses this button, the second and third speech types can be set.

Referring to FIG. 5, Object 955 is a UI object for designating a read speed and a pitch during speech synthesis. In this example, a movable slide bar is included. The file generation program sets the read speed and the pitch in accordance with a position of the movable slide bar.

Object 956 is a UI object for designating a presence or absence of a subtitle, and in this embodiment includes a radio button. The subtitle configuration includes three options, “YES,” “NO,” and “tag-designation.” If “YES” is selected, the file generation program sets the subtitle to be displayed in the video. If “NO” is selected, the file generation program sets the subtitle to not be displayed in the video. If “tag-designation” is selected, the file generation program sets the notes to be displayed as subtitles only for the character strings (in this case, the character strings within the tags <subtitle> and </subtitle>).

Object 957 is a UI object for designating a slide interval, and in this example includes a numeric box. The file generation program sets a blank for a designated time in object 957 for insertion between two consecutive slides. Specifically, the audio temporarily stops when an image of a previous slide is continuously displayed, and a time without audio (blank time) continues, and thereafter, a screen of a next slide is shown and audio starts playing.

Object 958 is a UI object for designating a presence or absence of translation. In this example, object 958 includes radio button 9581, check box 9582, pull-down menu 9583, check box 9584, button 9585, text box 9586, and button 9587.

Radio button 9581 is a UI object for designating a presence or absence of translation. If “YES” is selected, the file generation program sets the notes to be translated. If “NO” is selected, the file generation program sets notes not to be translated, and grays out other UI objects included in object 958. Checkbox 9582 is a UI object that designates whether a file including audio data is generated. If check box 9582 is checked, the file generation program only translates the presentation file and does not generate a file including audio data. If check box 9582 is not checked, the file generation program converts the translated presentation file into a file that includes audio data in addition to the translation of the notes included in the presentation file. Pull-down menu 9583 is a UI object for selecting a translation-engine. Storage means 11 in server 10 stores database 114. Database 114 is a database that records the attributes of the translation engine. The file generation program refers to database 114 and displays pull-down menu 9583.

Checkbox 9584 is a UI for designating whether a glossary is used. If “YES” is selected, the file generation program sets the glossary to be used when translating. If “NO” is selected, the file generation program sets the glossary to not be used when translating. If the button 9585 is pressed, the file generation program displays a glossary. In this example, the glossary is stored in database 112 in server 10. The file generation program accesses server 10 to read the glossary.

Text box 9586 is a UI for inputting or editing an output file name of the presentation file in which the notes are translated. Button 9587 is a UI object for calling a UI object (e.g., a dialog box) that designates the output file of the presentation file that translated the notes. The file generation program provides the file name designated in text box 9586 and saves the presentation file that has been translated into a note.

Object 959 is a UI object for calling a UI object (e.g., a dialog box) for configuration of testing speech synthesis. If configuration of testing the speech synthesis is instructed via the object 959, the file generation program calls the UI object for performing the configuration of the test.

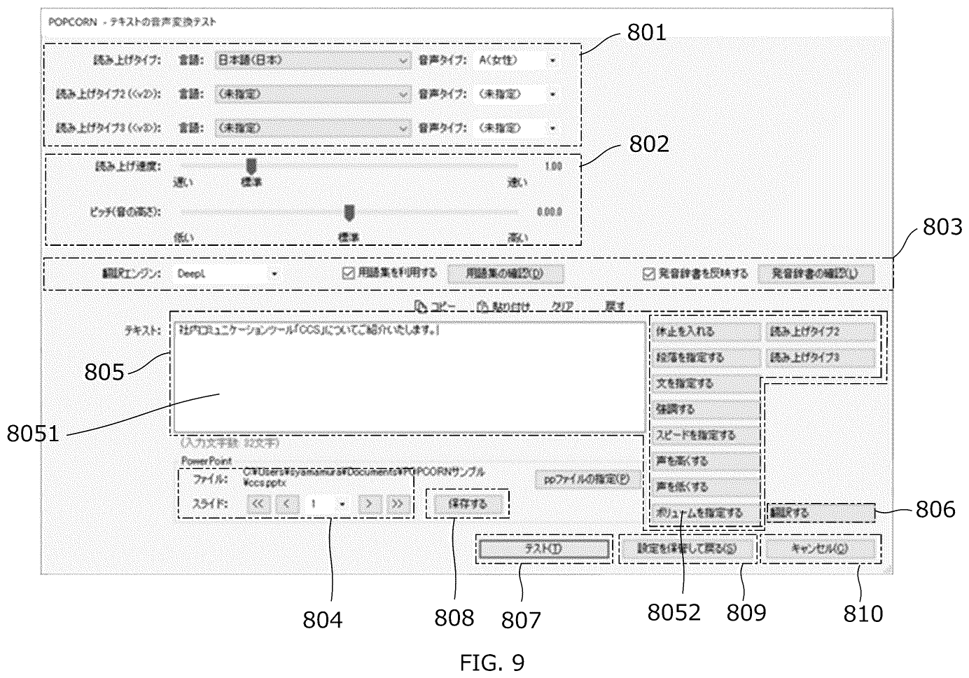

FIG. 9 shows an exemplary UI object that performs a test configuration. The UI object includes objects 801 to 810. Object 801 is a UI object for designating a speech type. The speech type refers to a combination of a language and a voice type. In this example, synthesized speech of notes is performed using attributes or parameters designated by a predetermined markup language, e.g. SSML (Speech Synthesis Markup Language) or a SSML compliant or similar language. In this case, speech type switching can be designated by use of a predetermined tag (<vn>). Specifically, three speech types can be designated (n is an integer from 1 to 3). For speech types 1, 2, and 3, the combination of the language and the voice type designated in object 954 is automatically set by the file generation program as an initial value. The user can also change the speech type 1 from the initial value. That is, the file generation program receives (at step S122, FIG. 6) the designation of the voice in the object 801. In this case, receiving the designation of the speech corresponds to receiving (at steps S123 and S124, FIG. 6) the designation of a speech synthesis engine and a language.

Object 802 is a UI object for designating a read speed and a pitch. In this example, object 802 includes a slide bar. As the initial values of the reading speed and the pitch, the reading speed and the voice type designated in the object 955 are automatically set by the file generation program. The user can change the reading speed and the pitch from the initial values by operating object 802.

Object 803 is a UI object for designating whether to use a glossary and whether to update a pronunciation dictionary. The translation engine designated in pull-down menu 9583 is automatically set by the file generation program as the initial value of the translation engine. Whether the glossary designated in check box 9584 is used is automatically set by the file generation program as an initial value of whether the glossary is used. Whether the pronunciation dictionary designated in object 953 is used is automatically set by the file generation program as an initial value of whether the pronunciation dictionary is used. By operating object 803, the user can change whether the translation engine and the glossary are used, and whether the pronunciation dictionary is updated from the initial value. In other words, the file generation program receives (at step S125, FIG. 6) the designation of the translation engine in object 803.

Object 804 is a UI object for designating a slide including notes to be edited. Object 804 includes a spin box. The file generation program designates a note of a slide that has a number displayed in the spin box as an editing target. In this example, object 804 further includes a button for calling a dialog box for designating the presentation file. By way of this dialog box, the file generation program receives the designation of the presentation file.

Object 805 is a UI object for editing a note. Object 805 includes text box 8051 and button 8052. If the slide designated in object 804 is changed, the file generation program extracts (i.e., reads) (at step S121, FIG. 6) a note in the designated slide from the presentation file. The file generation program displays the text of the read note in text box 8051. The user can add, replace, and delete character strings in the note in text box 8051. That is, the file generation program receives (at step S126, FIG. 6) an instruction to edit a note.

Button group 8052 is a button group for inserting a tag for designating an attribute of speech synthesis described in a predetermined markup language into a note to be edited. In this example, button group 8052 includes ten buttons: “put a pause,” “designate a paragraph,” “designate a sentence,” “emphasize,” “designate a speed,” “higher the pitch,” “lower the pitch,” “designate a volume,” “speech type 2,” and “speech type 3.” By pressing these buttons, the file generation program can receive (at step S126, FIG. 6) an instruction to edit a note.

The button “pause” is a button for inserting a tag (in this case, <break time></break>) for designating a pause. If this button is pressed, the file generation program displays a dialog box for designating a pause time.

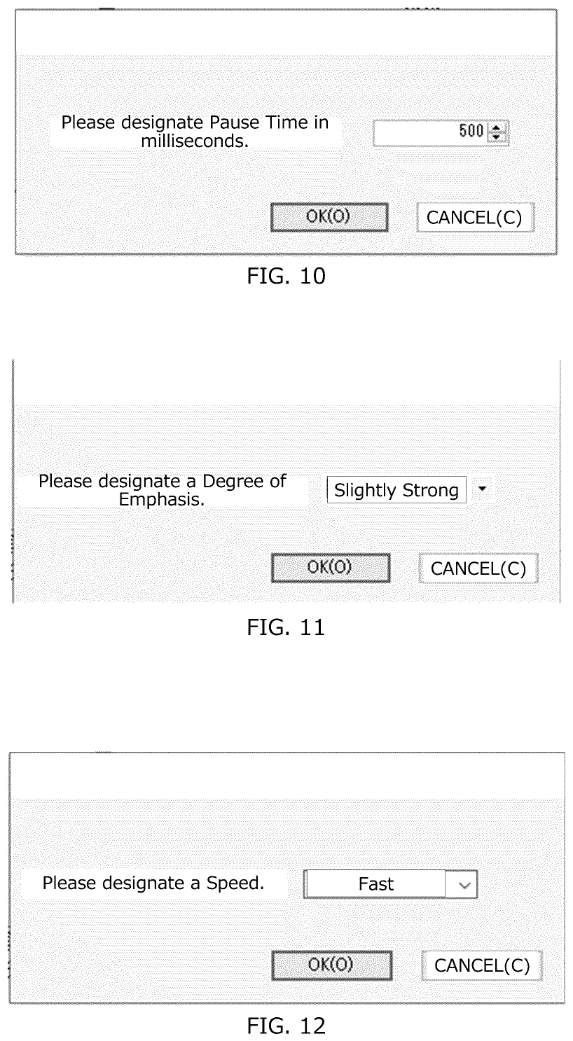

FIG. 10 shows an exemplary dialog box for designating a pause time. The user can designate a pause time in this dialog box. When OK button is pressed, the file generation program inserts a tag in text box 8051 (shown in FIG. 9) at a position where the cursor is present, for indicating the designated pause time. In this example, the tag <break time=“500 ms”></break> is inserted.

Referring to FIG. 9, the button “Designate paragraph” is a button for inserting a tag (in this example, <p></p>) for designating a paragraph. When this button is pressed, the file generation program inserts a tag designating a paragraph at a position where the cursor is present in text box 8051. When this button is pressed while a character string is selected in text box 8051, the file generation program inserts a tag <p> at the beginning of the selected character string and a tag </p> at the end of the selected character string.

The button “Designate Statement” is a button for inserting a tag (in this example, <s></s>) for designating a statement. If this button is pressed, the file generation program inserts a tag designating the sentence at a position where the cursor is present in text box 8051. If this button is pressed while a character string is selected in text box 8051, the file generation program inserts a tag <s> at the beginning of the selected character string and a tag </s> at the end of the selected character string.

The button “emphasis” is a button for inserting a tag (in this case, <emphasis></emphasis>) designating an emphasis. If this button is pressed, the file generation program displays a dialog box for designating a degree of emphasis.

FIG. 11 shows an exemplary dialog box for designating a degree of emphasis. The user can designate a degree of emphasis in this dialog box. If OK button is pressed, the file generation program inserts a tag indicating a designated degree of emphasis in text box 8051 (shown in FIG. 9) at a position where the cursor is present. In this example, the tag <emphasis level=“moderate”></emphasis> is inserted. If this button is pressed while a character string is selected in text box 8051, the file generation program inserts a tag <emphasis level=“moderate”> at the beginning of the selected character string and a tag </emphasis> at the end of the selected character string.

Referring to FIG. 9, button “Designate Speed” is a button for inserting a tag (in this case, <prosody rate ></prosody>) for designating emphasis. If this button is pressed, the file generation program displays a dialog box for designating a speed.

FIG. 12 shows an exemplary dialog box for designating a speed. The user can designate a speed in this dialog box. If OK button is pressed, the file generation program inserts a tag indicating the designated speed in text box 8051 (shown in FIG. 9) at a position where the cursor is present. In this example, the tag <prosody rate=“fast”></prosody> is inserted. If this button is pressed while a character string is selected in text box 8051, the file generation program inserts a tag <prosody rate=“fast”> at the beginning of the selected character string and a tag </prosody> at the end of the selected character string.

Referring to FIG. 9, the buttons “higher the pitch” and “lower the pitch” are buttons for inserting tags (in this case, <prosody pitch></prosody>) that designate a height (i.e., pitch or pitch) of the voice. When this button is pressed, the file generation program displays a dialog box for designating an amount by which the pitch is raised or lowered.

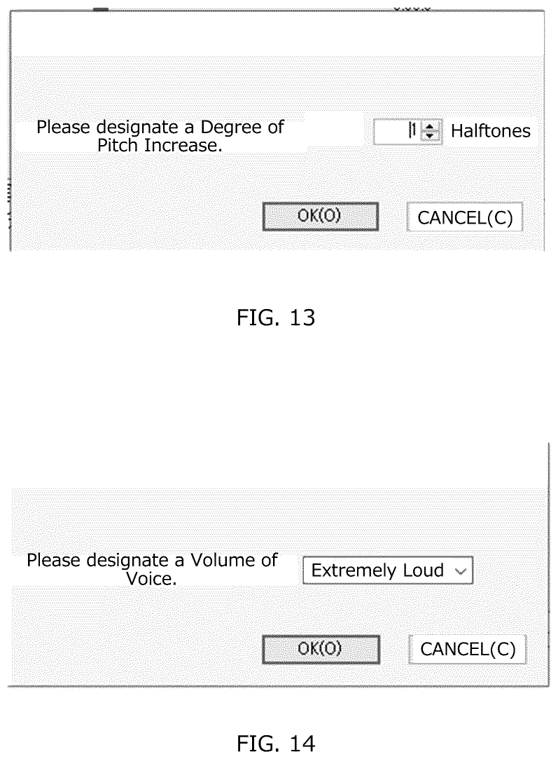

FIG. 13 shows an exemplary dialog box for designating the pitch of a voice (an example in which a button “higher the pitch” is pressed). The user can designate a pitch of the voice in this dialog box. If OK button is pressed, the file generation program inserts a tag indicating a pitch height of the designated voice in text box 8051 (shown in FIG. 9) at a position where the cursor is present. In this example, the tag <prosody pitch=“+1st”></prosody> is inserted. If this button is pressed while a character string is selected in text box 8051, the file generation program inserts a tag <prosody pitch=“+1st”> at the beginning of the selected character string and a tag </prosody> at the end of the selected character string.

Referring to FIG. 9, the button “Designate Volume” is a button for inserting a tag (in this case, <prosody volume></prosody>) for designating a volume (i.e., loudness). If this button is pressed, the file generation program displays a dialog box for designating the volume.

FIG. 14 shows an exemplary dialog box for designating a volume. The user can designate a volume in this dialog box. If OK button is pressed, the file generation program inserts a tag indicating a designated volume in text box 8051 (shown in FIG. 9) at a position where the cursor is present. In this example, the tag <prosody volume=“x-loud”> tag </prosody> is inserted. If this button is pressed while a character string is selected in text box 8051, the file generation program inserts a tag <prosody volume=“x-loud”> at the beginning of the selected character string and a tag </prosody> at the end of the selected character string.

Referring to FIG. 9, buttons “Speech type 2” and “Speech type 3” are buttons for inserting tags (in this example, <v2></v2> and <v3></v3>) that respectively change the Speech type to “Speech type 2” and “Speech type 3.” If this button is pressed, the file generation program inserts a tag designating the speech type at a position where the cursor is present in text box 8051. If this button is pressed while a character string is selected in text box 8051, the file generation program inserts a tag <v2> or <v3> at the beginning of the selected character string and a tag </v2> or </v3> at the end of the selected character string.

Object 806 is a UI object for translating notes, and in this example is a button. In this example, the language to be translated is a language included in the speech type designated by the object 801. If this button is pressed, the file generation program requests the translation engine designated by object 803 to translate using the text of the note as the source text. In this case, if the text of the note includes a tag conforming to SSML, the file generation program requests the translation engine to translate the text from which the tag has been deleted as the source text. The speech synthesis engine generates a translated sentence such that a sentence of the source text is translated into a target translation language in accordance with the request from the file generation program. The speech synthesis engine transmits the generated translation to the file generation program (that is, user terminal 20). The file generation program displays in text box 8051 the translation obtained from the translation engine.

Object 807 is a UI object for testing speech synthesis, and in this example is a button. If this button is pressed, the file generation program transmits a speech synthesis request to the speech synthesis engine corresponding to the language and speech type designated in the object 801, the speech synthesis request including the text of the note as a target sentence. The file generation program refers to database 113 and identifies the speech synthesis engine to which the speech synthesis request is to be transmitted. The speech synthesis engine synthesizes the target sentence in accordance with the request from the file generation program. The speech synthesis engine transmits the generated audio data to the file generation program (that is, user terminal 20). The file generation program obtains (at step S127, FIG. 6) audio data from the speech synthesis engine. The file generation program plays (at step S128, FIG. 6) the obtained audio data, that is, test-plays the obtained audio data.

Object 808 is a UI object, in this example a button, used for writing edited notes to the presentation file. If this button is pressed, the file generation program replaces notes of the slide to be edited (the slide designated in object 804 in this example) in the presentation file with the text displayed in text box 8051. That is, the file generation program writes (at step S129, FIG. 6) the edited notes to the presentation file.

Object 809 is a UI object, in this example a button, used for updating the configuration performed on the screen in FIG. 9. If this button is pressed, the file generation program stores configurations edited on the screen in FIG. 9 (e.g., speech type, translation engine, glossary usage, pronunciation dictionary usage, etc.). In this example, if the screen of the test configuration in FIG. 9 is closed, the screen returns to the configuration screen in FIG. 5, but if the configuration is not saved, the configuration performed on the screen in FIG. 9 is cancelled. If the configuration is saved, the configuration performed on the screen in FIG. 9 is updated when the screen returns to the configuration screen in FIG. 5. Object 810 is a UI object, a button in this case, used for canceling the configuration performed on the screen in FIG. 9.

Referring to FIG. 5 again. Object 960 is a UI object, a button in this case, used for instructing generation of a file including audio data. If this button is pressed, the file generation program converts (at step S13, FIG. 4) the presentation file into a file including audio data. More specifically, images of slides and audio data obtained by audio synthesis of notes are combined to generate a file including audio data in a predetermined format (for example, mp4 format). When generating a file including audio data, the file generation program determines a timing of switching the slides in accordance with time length of audio data of notes included in the slides. For example, if the audio data of a note included in the slide of the first page is 30 seconds long, the file generation program displays the slide of the first page for 36 seconds including a predetermined blank (time designated in the object 957, for example, 6 seconds), and generates a video file that switches to the slide of the second page after 36 seconds have elapsed.

### 3. Modification

The present invention is not limited to the embodiments described above, and various modifications may be applied. Some variations will be described below. At least some of the items described in the following modification may be combined with other item(s).

The functions of the file generation program are not limited to those described in the embodiment. Part of the functions described in the embodiment may be omitted. For example, the file generation program need not have a translation function. The file management program may operate in cooperation with other programs, and may be invoked from other programs that are started.

The method of designating the slide to be processed is not limited to the example described in the embodiment. The slide to be processed may be designated by, for example, a keyword search.

In the embodiment, plural options are described for the speech synthesis engine and the translation engine, along with description of an example by which the user can select a speech synthesis engine or translation engine for use. However, at least one of the speech synthesis engines and the translation engine need not be provided with options, and may be fixed by file generation system 1.

The file generation program may include a UI object for testing and playing generated video. According to this example, it is possible to confirm an effect of a corrected configuration.

UIs used in the file generation program are not limited to the examples described in the embodiment. In embodiment, for example, UI objects described as buttons may be other UI objects, such as checkboxes, slide bars, radio buttons, or spin boxes. In addition, some of the functions described as those of the file generation program in the embodiment may be omitted.

The format of the file including audio data output by the file generation program is not limited to the examples described in the embodiment. A file including audio data outputted by the file generation program may be of any type, such as a video file (mpeg4, etc.), a presentation file (Power Point (registered trademark) file, etc.), an e-learning teaching material file (SCORM, etc.), an audio-added html file, etc.

The relationship between the functional elements and the hardware elements is not limited to the examples described in the embodiment. At least a part of the functions described as being implemented in user terminal 20, may be implemented in a server such as server 10. For example, at least a part of the receiving means 22, extracting means 23, obtaining means 24, playing means 25, receiving means 26, writing means 27, and converting means 28 may be implemented in server 10. In one example, the file generation program may be a so-called web application running on server 10, rather than an application program installed in user terminal 20.

The hardware configuration of file generation system 1 is not limited to the examples described in the embodiment. Plural computer devices may physically cooperate with each other to function as server 10. Alternatively, a single physical device may provide the functions of server 10, server 30, and server 40. Each of server 10, server 30, and server 40 may be a physical server or a virtual server (for example, a so-called cloud). Further, at least a part of server 10, server 30, and server 40 may be omitted.

The program executed by CPU 210 or other element(s) may be provided while being stored in a non-transitory storage medium such as a DVD-ROM or may be provided via a network such as the Internet.

1. A program for causing a computer to execute a process, the process comprising:
receiving a designation of a presentation file that includes a plurality of slides, each including a note;
extracting character strings of a note from one of the plurality of slides;
obtaining audio data obtained by speech synthesis of the note;
playing the obtained audio data;
receiving an instruction to edit the character strings of the note;
writing the edited character strings of the note into the slide; and
converting the presentation file including the slide into a file including the audio data, the file having a file format different from that of the presentation file.

2. The program according to claim 1, the process further comprising
receiving an input to designate a voice for playing the audio data.

3. The program according to claim 1, the process further comprising:
receiving an input to designate a speech synthesis engine which carries out speech synthesis of the note; and
obtaining the audio data from the designated speech synthesis engine.

4. The program according to claim 1, the process further comprising:
displaying on a display a UI object for editing the note.

5. The program according to claim 4, wherein
the UI object includes a button for inserting a tag of SSML (Speech Synthesis Markup Language).

6. The program according to claim 4, wherein
the UI object includes a button for testing and playing the audio data.

7. The program according to claim 4, wherein
the UI object includes a button for testing and playing the file including the audio data.

8. The program according to claim 1, the process further comprising
obtaining a translation of the note, in a target language.

9. The program according to claim 8, the process further comprising
receiving an input to designate the translation target language.

10. A computer-implemented file generation method comprising:
receiving a designation of a presentation file that includes a plurality of slides, each including a note;
extracting character strings of a note from one of the plurality of slides;
obtaining audio data obtained by speech synthesis of the note;
playing the obtained audio data;
receiving an instruction to edit the character strings of the note;
writing the edited character strings of the note to a slide; and
converting the presentation file including the slide to a file including the audio data, the file having a file format different from that of the presentation file.

11. An information processing device comprising:
a file receiving means for receiving a designation of a presentation file including plural slides each including a note;
an extracting means for extracting character strings of a note from one of the plurality of slides;
an obtaining means for obtaining audio data obtained by speech synthesis of the extracted note;
a playing means for playing the obtained audio data;
an instruction receiving means for receiving an instruction to edit the extracted character strings of the note;
a writing means for writing the edited character strings of the note to the slide; and
a converting means for converting the presentation file including the edited slide into a file including the audio data, the file having a file format different from that of the presentation file.

12. An information processing system comprising:
a file receiving means for receiving a designation of a presentation file including plural slides each including a note,
an extracting means for extracting character strings of a note from one of the plurality of slides;
an obtaining means for obtaining audio data obtained by speech synthesis of the extracted note;
a playing means for playing the obtained audio data;
an instruction receiving means for receiving an instruction to edit the extracted character strings of the note;
a writing means for writing the edited character strings of the note to the slide; and
a converting means for converting the presentation file including the slide into a file including the obtained audio data, the file having a file format different from that of the presentation file.

13. The program according to claim 1, wherein
in the converting, a timing to switch from a first slide to a second slide is determined on the basis of a time length of the audio data of the note included in the first slide.
